(19) United States
(12) Patent Application Publication
(10) Pub. No.: US 2015/0001199 A1
(43) Pub. Date: Jan. 1, 2015

(54) Customized Shoe Insole and Customized Sandal

(71) Applicant: Dongmin Jeon, Busan (KR)

(72) Inventor: Dongmin Jeon, Busan (KR)

(21) Appl. No.: 14/377,695

(22) PCT Filed: Aug. 20, 2012
(86) PCT No.: PCT/KR2012/006590

§ 371 Date: Aug. 8, 2014

(30) Foreign Application Priority Data
Feb. 9, 2012 (KR) 10-2012-0013148
Aug. 14, 2012 (KR) 10-2012-0089035

(51) Int. Cl. A43B 7/04; A43B 3/12; H05B 3/02

(52) U.S. Cl. CPC A43B 7/04; H05B 3/02; A43B 3/12
USPC 219/201

(57) ABSTRACT

The present invention relates to a customized shoe insole and to a customized sandal. More particularly, a customized shoe insole comprises a surface layer, an upper layer unit, a heating sheet including a heating portion and an electrode portion, a thermoplastic resin sheet, and a power supply terminal. The heating sheet includes the heating portion, which has a heating circuit formed by printing a conductive paint that contains fine powder of one or a mixture of two or more elements selected from silver (Ag), carbon (C), and copper (Cu) on a polyethylene (PE), polyethyleneterephthalate (PET), polycarbonate (PC) or polyimide (PI) resin film, and the electrode portion which is precisely connected to the power supply terminal. The heating circuit is repeatedly arranged by once or twice or more so as to form a zigzag shape with predetermined intervals thereafter, and repeatedly arranged again by once or twice or more so as to form a heating circuit. At least one of the intervals forms a cutting line while maintaining a predetermined distance from the heating circuit inwardly from an outer surface of the heating sheet such that the heating sheet can tightly contact a foot-shaped thermoplastic resin sheet having a curvature. Thus, the customized shoe insole can be made to completely fit the shape and characteristics of the foot of the wearer while maintaining a predetermined molding temperature by the heating sheet. Therefore, a customized sandal can be produced with which the customized shoe insole is integrally formed so as to maximize wearing comfort and minimize fatigue.

### TECHNICAL FIELD

This invention relates to a customized shoe insole and a customized sandal maximizing wearing comfort and minimizing fatigue by fabricating them to fit into the shape of the customer's sole.

### BACKGROUND ART

The prosthetic footwear such as the shoe insoles and the like which are being distributed in the market nowadays have been fabricated using soft materials in order to reduce impact force applied to the foot or improve bottom surface thereof. However, since such shoe insoles are mass produced in the factory with reference to the average ordinary person's foot shape, so they are not perfectly matched to the shape and the characteristics of the individual persons.

Thus, in order to solve above mentioned problem, a technology had been disclosed for distribution and fabrication of the shoe insoles being fitted into the shape of the wearer's foot.

Korea Utility Model No. 435, 458 discloses a customized molding technology of a shoe insole, wherein a multi-structured shoe insole comprising an EVA layer for the bottom layer, a polyurethane layer for the middle layer, and a fiber layer for the top layer, is disposed inside an electronic oven followed by heating, then it is inserted into the shoe for contacting with the wearer's foot so as to fit into the shape of the wearer's sole. However, the above described patent technology has problems therewith, wherein it basically requires an electronic oven for heating a shoe insole disposed therein, and the process of fabricating the shoe insole is a quite hassle and takes a long time. Moreover, since solidification starts to begin due to the immediate cooling right after the shoe insole is taken out from the electronic oven, so there is a concern of a shoe insole molding which does not match with the shape and the characteristics of the wearer's foot due to the rapid solidification in some cases.

### DETAILED DESCRIPTION OF INVENTION

### Technical Problem

The present invention is to solve the foregoing problems, and an objective of the present invention is to provide a customized shoe insole capable of molding thereof allowing a perfect matching with the shape and the characteristics of the wearer's foot by embedding the heating portion and the electrode portion inside of the shoe insole.

In addition, another objective of the present invention is to provide a customized sandal such that wearing comfort is maximized and fatigue is minimized by integrally providing said customized shoe insole therein.

### Solution to Problem

To achieve the foregoing objectives, the present invention provides a customized shoe insole being characterized in that and includes: a surface layer including a fiber material being contacted with the sole of the wearer's foot; an upper layer unit being stacked under said surface layer and for absorbing the impact while walking; a heating sheet being stacked under said upper layer unit and including a heating portion and an electrode portion; a thermoplastic resin sheet being stacked under said heating sheet and capable of molding thereof by the heat generated in said heating sheet; and a power supply terminal capable of supplying an AC or a DC to said heating sheet, wherein

said heating sheet includes: a heating portion comprising a heating circuit, wherein said heating circuit is formed by printing with silver (Ag), carbon (C) or copper (Cu) on a polyethylene (PE), polyethylene terephthalate (PET), polycarbonate (PC) or polyimide (PI) resin film; and an electrode portion being precisely connected to said heating circuit of said heating portion and the power supply terminal

wherein said heating circuit is repeatedly arranged by once or twice or more so as to form a zigzag shape with predetermined intervals thereafter, and repeatedly arranged again by once or twice or more so as to form a heating circuit; a cutting line is formed while maintaining at least more than one of said predetermined distance from the heating circuit inwardly from an outer surface of the heating sheet such that said heating sheet is tightly in contact with a foot-shaped thermoplastic resin sheet having a curvature.

The present invention provides a customized sandal being characterized in that and includes: a bottom layer directly contacting the ground; a middle layer being stacked on the top of said bottom layer for absorbing the impact while walking; a heating sheet being stacked on the top of said middle layer and including a heating portion and an electrode portion; a thermoplastic resin sheet being stacked on the top of said heating sheet and capable of molding thereof by the heat generated in said heating sheet; a surface layer being stacked on the top of said thermoplastic resin sheet and including a fiber material contacting wearer's sole; a strap being inserted and fixed between said bottom layer and said middle layer, and encompassing the instep; and a power supply terminal capable of supplying an AC or a DC to said heating sheet, wherein

said heating sheet includes: a heating portion comprising a heating circuit, wherein said heating circuit is formed by printing with a conductive paint containing fine powder of one or a mixture of two or more elements selected from silver (Ag), carbon (C), and copper (Cu) such as XA-436, FA-545, XA-824, FC-403R, XC-223, FA501, and the like produced by Fujikura Kasei Co. Ltd, on a polyethylene (PE), polyethyleneterephthalate (PET), polycarbonate (PC) or polyimide (PI) resin film; and an electrode portion being precisely connected to said heating circuit of said heating portion and the power supply terminal, wherein said heating circuit is repeatedly arranged by once or twice or more so as to form a zigzag shape with predetermined intervals thereafter, and repeatedly arranged again by once or twice or more so as to form a heating circuit; a cutting line is formed while maintaining at least more than one of said predetermined distance from the heating circuit inwardly from an outer surface of the heating sheet such that said heating sheet is tightly in contact with a foot-shaped thermoplastic resin sheet having a curvature; and said electrode portion is configured to be extended out from the end of the shoe insole or towards the bottom side thereof.

Further, in order to solve a problem that the heating circuit of said customized shoe insole and sandal is easily susceptible to a circuit damage from a small external impact by oxidation in air or while working, a reinforce printing of the printed heating circuit on a polyethylene (PE), polyethylene terephthalate (PET), polycarbonate (PC) or polyimide (PI) resin film with an insulating ink, may be added, or a polyethylene (PE), polyethylene terephthalate (PET), polycarbonate (PC) or polyimide (PI) resin film, and the like may be stacked thereon.

In addition, the heating circuit of the heating portion being printed on the heating sheet maybe printed using the method of Gravure printing, screen printing, or etching.

### Advantageous Effects of Invention

A customized shoe insole and a customized sandal of the present invention do not require a separate heating apparatus such as microwave oven, an electronic oven, and the like, and they can be molded to completely fit the shape and characteristics of the foot of the wearer while maintaining a predetermined molding temperature by the heating sheet.

In addition, the customized shoe insole of the present invention has an electrode portion is formed outwardly extended towards the bottom side of the shoe insole, this can solve the existing problems of the conventional method wherein the electrode portion is being externally exposed passing through the end of the heel such that the punching dies become complicated to avoid the damage from the cutting knife for punching out the perimeter of the shoe insole; the appearance after punching is not so good; a deformation occurs in the electrode portion and the neighborhood thereof; the workability is degraded, and the like.

### BRIEF DESCRIPTION OF DRAWINGS

FIG. 1 is a cross-sectional view of a customized shoe insole molded by the weight of the wearer according to an exemplary embodiment of the present invention.

FIG. 2 is a cross-sectional view wherein a heating sheet formed to have an electrode portion extended towards the end of the shoe insole, is stacked on a thermoplastic resin according to an exemplary embodiment of the present invention.

FIG. 3 is a cross-sectional view wherein a heating sheet formed to have an electrode portion extended towards the bottom side, is stacked on a thermoplastic resin according to an exemplary embodiment of the present invention.

FIG. 4 is a perspective view of a customized sandal according to an exemplary embodiment of the present invention.

FIG. 5 is a cross-sectional view of a customized sandal molded by the weight of the wearer according to an exemplary embodiment of the present invention.

### DETAILED DESCRIPTION OF EMBODIMENT

Hereinafter, a customized shoe insole and a customized sandal according to the present invention will be described in detail with reference to the accompanying drawings.

### (1) Customized Shoe Insole

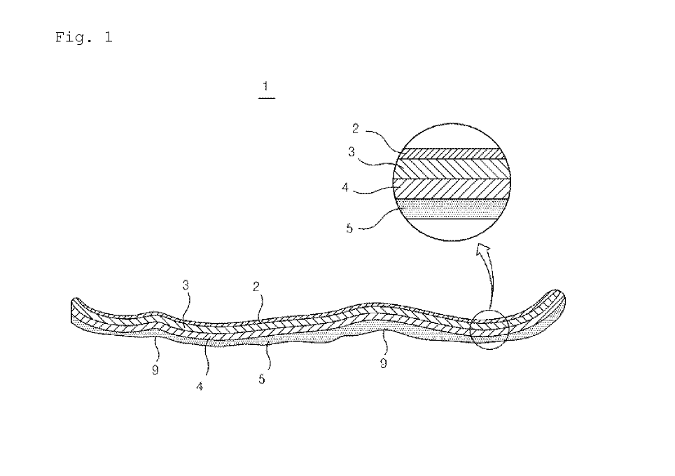

As illustrated in FIGS. 1 to 3, a customized shoe insole (1) according to the present invention includes: a surface layer (2) including a fiber material being contacted with the sole of the wearer' s foot; an upper layer unit (3) being stacked under said surface layer (2) and for absorbing the impact while walking; a heating sheet (4) being stacked under said upper layer unit (3) and including a heating portion (4a) and an electrode portion (4b); a thermoplastic resin sheet (5) being stacked under said heating sheet (4) and capable of molding thereof by the heat generated in said heating sheet (4); and a power supply terminal (6) capable of supplying an AC or a DC to said heating sheet (4).

More specifically, a customized shoe insole (1) characterized in that wherein said heating sheet (4) includes: a heating portion (4a) comprising a heating circuit (7) wherein said heating circuit (7) is formed by printing with a conductive paint containing fine powder of one or a mixture of two or more elements selected from silver (Ag), carbon (C) or copper (Cu) on a polyethylene (PE), polyethylene terephthalate (PET), polycarbonate (PC) or polyimide (PI) resin film; and an electrode portion (4b) being precisely connected to said heating circuit (7) of said heating portion (4a) and the power supply terminal (6), wherein said heating circuit (7) is repeatedly arranged by once or twice or more so as to form a zigzag shape with predetermined intervals thereafter, and repeatedly arranged again by once or twice or more so as to form a heating circuit (7); a cutting line (8) is formed while maintaining at least more than one of said predetermined distance from the heating circuit (7) inwardly from an outer surface of the heating sheet (4) such that said heating sheet (4) is tightly in contact with a foot-shaped thermoplastic resin sheet (5) having a curvature, is provided.

The surface layer (2) which constitutes the customized shoe insole (1) according to the present invention includes a fiber material contacting with the sole of the wearer. It is preferred that a soft material is used as said fiber material capable of enhancing the wearing comfort by directly contacting with the wearer's skin. More specifically, cotton textile, synthetic fiber, non-woven fabric, urethane, latex, EVA, and the like maybe used as said fiber material.

The upper layer unit (3) which constitutes the customized shoe insole (1) according to the present invention is stacked under said surface layer (2), serves for absorbing the impact while walking. In other words, anything that can absorb the impact transmitted from the wearer's sole or from the ground is good for an upper layer unit (3)

The heating sheet (4) which constitutes the customized shoe insole (1) according to the present invention is stacked under said upper layer unit (3), and includes a heating portion (4a) and an electrode portion (4b), and the heating portion (4a) which includes a heating circuit (7) may be formed across the total area of the shoe insole, or the limited area thereof.

Said heating sheet (4) includes: a heating portion (4a) comprising a heating circuit (7), wherein said heating circuit (7) is formed by printing with a conductive paint containing fine powder of one or a mixture of two or more elements selected from silver (Ag), carbon (C), and copper (Cu) such as XA-436, FA-545, XA-824, FC-403R, XC-223, FA501, and the like produced by Fujikura Kasei Co. Ltd, on a polyethylene (PE), polyethyleneterephthalate (PET), polycarbonate (PC) or polyimide (PI) resin film; and an electrode portion (4b) being precisely connected to said heating circuit (7) of said heating portion (4a) and the power supply terminal (6), wherein said heating circuit (7) is repeatedly arranged by once or twice or more so as to form a zigzag shape with predetermined intervals thereafter, and repeatedly arranged again by once or twice or more so as to form a heating circuit (7).

Said heating circuit (7), which is a circuit formed by printing with a conductive paint or a mutually mixed conductive paint, is printed on the heating sheet (4) with a predetermined thickness; since the conductive paint is easily oxidized when exposed in air and susceptible to a damage from a small external impact while working, in order to solve such problems the total portion of the heating circuit (7) may be printed again with an insulation ink for reinforcement, or a polyethylene (PE), polyethylene terephthalate (PET), polycarbonate (PC) or polyimide (PI) resin film may be stacked above the heating circuit (7).

In addition, the heating circuit (7) printed on the electrode portion (4b) also can be oxidized when exposed in air, and if a precise contact is not established when connecting the power supply terminal (6) thereto a spark may occur, so the circuit may easily be damaged; thus, oxidation in air and sparks that may occur when connecting the power supply terminal (6), can be prevented by reinforcing a predetermined portion, about 5 mm to 10 mm, of the end portion thereof with a carbon ink; the remaining portion of the electrode portion (4b) can be protected from the electric shock or oxidation in air by additional reinforcement printing over it including the heating portion (4a) using an insulating ink, or stacking a PE, PET, PC, or PI like resin film.

A generally known method may be adopted for the printing of said heating circuit (7). More specifically, it may be accomplished by the method of Gravure printing, screen printing, or etching.

Said Gravure printing method forms a heating circuit (7) printed with a conductive paint on one side of a resin film by coating an ink on the perimeter surface of the printing cylinder containing the heating portion (4a), and tightly contacting said perimeter surface of the printing cylinder coated with said ink to said resin film.

Said screen printing method forms a heating circuit (7) by printing wherein the adjustment of the resistance of the heating element is achieved by using the thickness or the area of the conductive paint being printed, and adjusting the number of threads of the woven fiber mesh.

Said etching method prints a heating circuit (7) using a photosensitive masking ink on a negative plate wherein a copper foil is adhered on a polyethylene (PE), polyethylene terephthalate (PET), polycarbonate (PC) or polyimide (PI) resin film. Then, using an etching reagent such as ferric chloride (FeCl₂), copper chloride (CuCl₂), chloric acid (HClO₃), and the like the remaining portion except the printed portion with said masking ink is etched away such that only the circuit of the printed portion is remained, thereby forming a heating circuit (7).

In addition, a cutting line (8) is formed while maintaining a predetermined distance from the heating circuit (7) printed by the above mentioned method.

More specifically, a cutting line (8) is formed while maintaining at least more than one of said predetermined distance formed in said heating portion (4a) from the heating circuit (7) inwardly from an outer surface of the heating sheet (4).

Said cutting line (8) plays a role in close contacting and bonding of the heating sheet (4) with the thermoplastic resin sheet (5) having a foot-shaped curvature which will be described hereinafter.

It is preferred that said cutting line (8) is formed in a pattern having multi-directional slots for cutting thereof without damaging the heating circuit (7).

Heat is generated in the heating portion (4a) which is formed while a predetermined distance between said cutting line (8) and heating circuit (7) is being maintained. In other words, heat is generated since the smooth current flow is maintained due to the precise connection of the heating circuit (7) of said heating portion (4a) with the electrode portion (4b) which will be described hereinafter.

For generating heat from said heating portion (4a), a heating circuit (7) and an electrode portion (4b) precisely connected to the power supply terminal (6) which will be described hereinafter, are provided in the heating sheet (4).

Said electrode portion (4b) having a predetermined length has a shape of a pair of parallel ‘I’ character printed with the foregoing conductive paint.

Said conductive paint can be easily oxidized when exposed in air, and if a precise contact is not established when connecting the power supply terminal (6) thereto a spark may occur, so the circuit may easily be damaged. Thus, in order to prevent this problem, a predetermined portion, about 5 mm to 10 mm, of the end portion of the electrode portion (4b) may be reinforced with a carbon ink. In addition, the remaining portion of the electrode portion (4b) can be protected from the electric shock or oxidation in air by an additional reinforcement printing over it including the heating circuit (7) using an insulating ink, or stacking a polyethylene (PE), polyethylene terephthalate (PET), polycarbonate (PC) or polyimide (PI) resin film.

In addition, said electrode portion (4b) may be configured to be extended out from the end of the shoe insole or towards the bottom side thereof, and it is preferred to be extended out towards the bottom side of the shoe insole.

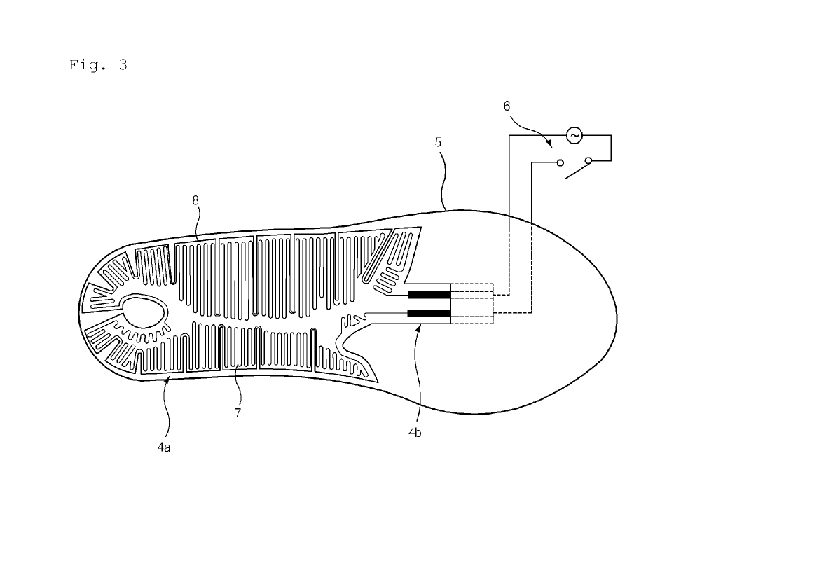

For an example, if the electrode portion (4b) in FIG. 3 is configured to be extended towards the bottom side of the shoe insole, even the electrode portion (4b) is removed after the customized shoe insole (1) is manufactured no apparent trace thereof will be remained, besides, the productivity and the commercial value may be increased. In addition, since a cutting process should be performed when the electrode portion (4b) is extended out from the end of the shoe insole, an additional work is necessary because the electrode portion (4b) is easily damaged by the cutting knife during the cutting process.

In addition, a power supply terminal (6) is provided capable of supplying an AC or a DC to the heating sheet (4) having said electrode portion (4b) therein. Said power supply terminal (6) is precisely connected to said electrode portion (4b), and supplies current to the heating circuit (7) in the heating sheet (4) after being supplied with electrical power from an external source.

The thermoplastic resin sheet (5) constituting a customized shoe insole (1) according to the present invention is being stacked under the lower side of said heating sheet (4) and may be molded by the heat generated from said heating sheet (4).

More specifically, said thermoplastic resin sheet (5) turns into a moldable state by receiving the heat generated from the heating portion (4a) when the electrode portion (4b) provided in said heating sheet (4) supplies current thereto. Thereafter, said thermoplastic resin sheet (5) is molded into a shape corresponding to the weight of the wearer, thus it may become a shape perfectly conformed to the shape and the characteristics of the wearer's sole.

Said thermoplastic resin sheet (5) is made of polymers produced through polymerization and condensation reactions, and the like of the monomers. If said polymer resin can be molded at the temperature of 60□ to 120□, and has characteristics that can be solidified by cooling at room temperature, it maybe used without limitation. More specifically, resin of one or a mixture of two or more resins of low density polyethylene (LDPE), linear low density polyethylene (LLDPE), ethylene vinyl acetate (EVA), or the like may be used.

For an example, a blowing agent and zinc oxide are mixed into the polymer resins such as low density polyethylene (LDPE), linear low density polyethylene (LLDPE), and the like; after that, if stearate, cross-linking agent, and filler are mixed therewith as other additives, then said thermoplastic resin sheet (5) may be produced.

More specifically, said thermoplastic resin sheet (5) may be produced by mixing 38-42 wt % of low density polyethylene (LDPE), 32-34 wt % of linear low density polyethylene (LLDPE), 1.4-2.0 wt % of blowing agent, 2.0-2.4 wt % of zinc oxide, 0.8-1.2 wt % of stearate, 0.8-1.2 wt % of cross-linking agent, 10-20 wt % of filler, and 5-7 w % of pigment.

Hereinafter a customized shoe insole (1) according to the present invention will be described.

As illustrated in FIGS. 1 to 3, after a thermoplastic resin sheet (5), a heating sheet (4), an upper layer unit (3), and a surface layer (2) are sequentially stacked, an adhesive is applied on the vertically neighboring stacking surfaces, and then an adhesion process is performed. After that, it is inserted into a press and pressed for a shape of a sole, and then a cutting process is performed to produce a model of a shoe insole.

Later, said thermoplastic resin sheet (5) turns into a moldable state by the heat generated from the heating portion (4a) of the heating sheet (4) when the power is applied to the heating portion (4a) of the heating sheet (4) through the power supply terminal (6) connected to the electrode portion (4b) of said shoe insole. At this moment, it is preferred that the power is applied for 10-20 minutes in order to reach a moldable state for said thermoplastic resin sheet (5).

After that, the power source to the power supply terminal (6) is cut-off, then when a wearer steps with said shoe insole inserted into the wearer's shoe, a curved portion (9) is produced by molding of the thermoplastic resin sheet (5) in a shape corresponding to the wearer's weight.

After the completion of the molding of said thermoplastic resin sheet (5), if the thermoplastic resin sheet (5) is cured for about 10-20 minutes at room temperature, a customized shoe insole (1) according to the present invention perfectly matching with the shape and the characteristics of the wearer's sole is produced.

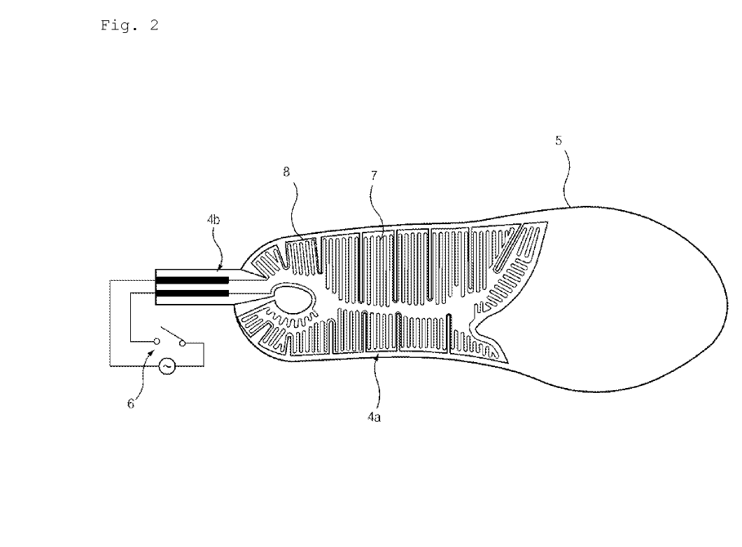

Said customized shoe insole (1) may be produced in a way that the electrode portion (4b) is configured to be extended out from the end of the shoe insole as shown in FIG. 2, and the electrode portion (4b) is configured to be extended out towards the bottom side of the shoe insole as shown in FIG. 3.

(2) Customized Sandal

Hereinafter, a customized sandal produced through configuring the main body of the sandal, which will be mentioned later, using said customized shoe insole will be described in detail.

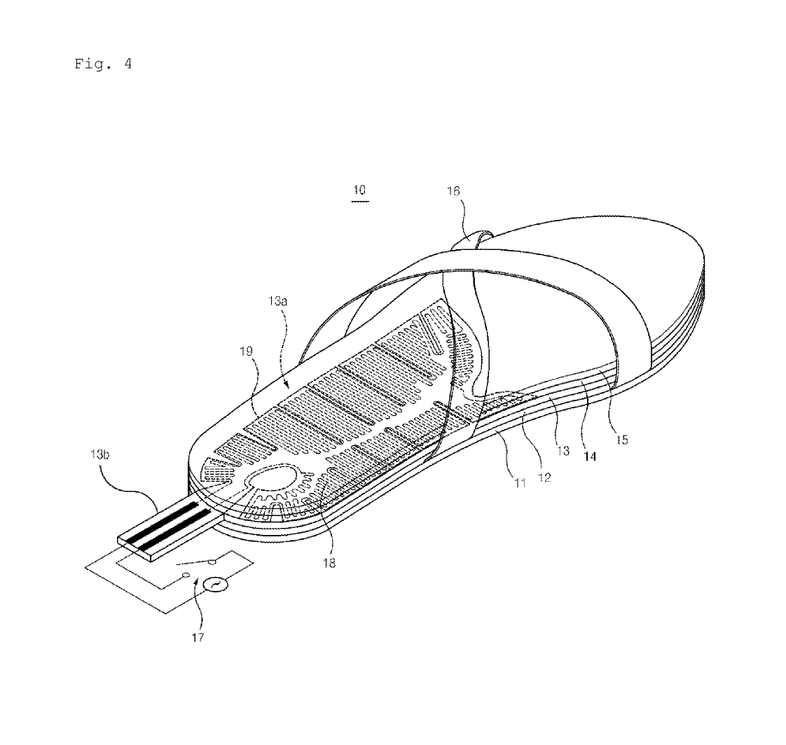

As illustrated in FIG. 4, a customized sandal (10) of the present invention includes: a bottom layer (11) directly contacting the ground; a middle layer (12) being stacked on the top of said bottom layer (11) for absorbing the impact while walking; a heating sheet (13) being stacked on the top of said middle layer (12) and including a heating portion (13a) and an electrode portion (13b); a thermoplastic resin sheet (14) being stacked on the top of said heating sheet (13) and capable of molding thereof by the heat generated in said heating sheet (13); a surface layer (15) being stacked on the top of said thermoplastic resin sheet (14) and including a fiber material contacting wearer's sole; a strap (16) being inserted and fixed between said bottom layer (11) and said middle layer (12), and encompassing the instep; and a power supply terminal (17) capable of supplying an AC or a DC to said heating sheet (13).

More specifically, the present invention provides a customized sandal (10) being characterized in that said heating sheet (13) includes: a heating portion (13a) wherein a heating circuit (18) is formed by printing with silver (Ag), carbon (C), and copper (Cu) on a polyethylene (PE), polyethyleneterephthalate (PET), polycarbonate (PC) or polyimide (PI) resin film; and an electrode portion (13b) being precisely connected to said heating circuit (18) of said heating portion (13a) and the power supply terminal (17), wherein said heating circuit (18) is repeatedly arranged by once or twice or more so as to form a zigzag shape with predetermined intervals thereafter, and repeatedly arranged again by once or twice or more so as to form a heating circuit (18); a cutting line (19) is formed while maintaining at least more than one of said predetermined distance from the heating circuit (18) inwardly from an outer surface of the heating sheet (13) such that said heating sheet (13) is tightly in contact with a foot-shaped thermoplastic resin sheet (14) having a curvature.

The bottom layer (11) constituting the customized sandal (10) according to the present invention is a layer which directly contacts ground; natural rubber, polyurethane, stylenebutadiene rubber, and the like may be used in order to enhance the ground-gripping power for contact with the ground surface.

The middle layer (12) which constitutes the customized sandal (10) according to the present invention is stacked above said bottom layer (11), serves for absorbing the impact while walking. In other words, anything that can absorb the impact transmitted from the wearer' s sole or from the ground is good for said middle layer (12).

The heating sheet (13) which constitutes the customized sandal (10) according to the present invention is stacked above said middle layer (12), and includes a heating portion (13a) and an electrode portion (13b), and may be formed across the total area of the sandal, or the limited area thereof.

Said heating sheet (13) includes a heating portion (13a) comprising a heating circuit(18) wherein said heating circuit (18) is formed by printing with a conductive paint containing fine powder of one or a mixture of two or more elements selected from silver (Ag), carbon (C), and copper (Cu) such as XA-436, FA-545, XA-824, FC-403R, XC-223, FA501, and the like produced by Fujikura Kasei Co. Ltd, on a polyethylene (PE), polyethyleneterephthalate (PET), polycarbonate (PC) or polyimide (PI) resin film.

More specifically, said heating circuit (18) is repeatedly arranged by once or twice or more so as to form a zigzag shape with predetermined intervals thereafter, and repeatedly arranged again by once or twice or more so as to form a heating circuit (18).

Said conductive paint is easily oxidized when exposed in air and susceptible to damage from a small external impact while working. Thus, in order to solve such problems the total portion of the heating circuit (18) may be printed again with an insulation ink for reinforcement, or a polyethylene (PE), polyethylene terephthalate (PET), polycarbonate (PC) or polyimide (PI) resin film may be stacked above the heating circuit (18).

A generally known method may be adopted for the printing of said heating circuit (18). More specifically, it may be accomplished by the method of Gravure printing, screen printing, or etching as described for said customized shoe insole (1).

In addition, a cutting line (19) is formed while maintaining a predetermined distance from the heating circuit (18) printed by the above mentioned method.

More specifically, said cutting line (19) is formed while maintaining at least more than one of said predetermined distance formed in said heating portion (13a) from the heating circuit (18) inwardly from an outer surface of the heating sheet (13).

Said cutting line (19) plays a role in close contacting and bonding of the heating sheet (13) with the thermoplastic resin sheet (14) having a foot-shaped curvature which will be described hereinafter.

It is preferred that said cutting line (19) is formed in a pattern having multi-directional slots for cutting thereof without damaging the heating circuit (18).

Heat is generated in the heating portion (13a) which is formed while a predetermined distance between said cutting line (19) and heating circuit (18) is being maintained. In other words, heat is generated since the smooth current flow is maintained due to the precise connection of the heating circuit (18) of said heating portion (13a) with the electrode portion (13b) which will be described hereinafter.

For generating heat from said heating portion (13a), heating circuit (18) and an electrode portion (13b) precisely connected to the power supply terminal (17) which will be described hereinafter, are provided in the heating sheet (13).

Said electrode portion (13b) having a predetermined length has a shape of a pair of parallel ‘I’ character printed with the foregoing conductive paint.

Said conductive paint can be easily oxidized when exposed to air, and if a precise contact is not established when connecting the power supply terminal (17) thereto a spark may occur, so the circuit may easily be damaged. Thus, in order to prevent this problem, a predetermined portion, about 5 mm to 10 mm, of the end portion of the electrode portion (13b) is reinforced with a carbon ink, and the remaining portion is configured such that it is protected from the electric shock or oxidation in air by an additional reinforcement printing over it including the heating portion (13a) using an insulating ink, or stacking PE, PET, PC, PI resin film, and the like.

In addition, said electrode portion (13b) is configured to be extended out from the end of the sandal.

In addition, a power supply terminal (17) capable of supplying an AC or a DC to said heating sheet (13) having said electrode portion (13b) is provided. Said power supply terminal (17) is precisely connected to said electrode portion (13b), and supplies current to the heating circuit (18) in the heating sheet (13) after being supplied with electrical power from an external source.

The thermoplastic resin sheet (14) constituting a customized sandal (10) according to the present invention is being stacked on the upper side of said heating sheet (13) and may be molded by the heat generated from said heating sheet (13).

More specifically, said thermoplastic resin sheet (14) turns into a moldable state by receiving the heat generated from the heating portion (13a) when the electrode portion (13b) provided in said heating sheet (13) supplies current thereto. Thereafter, said thermoplastic resin sheet (14) is molded into a shape corresponding to the weight of the wearer, thus it may become a shape perfectly conformed to the shape and the characteristics of the wearer's sole.

Said thermoplastic resin sheet (14) is made of polymers produced through polymerization and condensation reactions, and the like of the monomers. If said polymer resin can be molded at the temperature of 60□ to 120□, and has characteristics that can be solidified by cooling at room temperature, it maybe used without limitation. More specifically, resin of one or a mixture of two or more resins of low density polyethylene (LDPE), linear low density polyethylene (LLDPE), ethylene vinyl acetate (EVA), or the like may be used.

For an example, a blowing agent and zinc oxide are mixed into the polymer resins such as low density polyethylene (LDPE), linear low density polyethylene (LLDPE), and the like; after that, if stearate, cross-linking agent, and filler are mixed therewith as other additives, then said thermoplastic resin sheet (14) may be produced.

More specifically, said thermoplastic resin sheet (14) may be produced by mixing 38-42 wt % of low density polyethylene (LDPE), 32-34 wt % of linear low density polyethylene (LLDPE), 1.4-2.0 wt % of blowing agent, 2.0-2.4 wt % of zinc oxide, 0.8-1.2 wt % of stearate, 0.8-1.2 wt % of cross-linking agent, 10-20 wt % of filler, and 5-7 w % of pigment.

The surface layer (15) which constitutes the customized sandal (10) according to the present invention is stacked above said thermoplastic resin sheet (14) and includes a fiber material contacting with the sole of the wearer. It is preferred that a soft material is used as said fiber material capable of enhancing the wearing comfort by directly contacting with the wearer's skin. More specifically, cotton textile, synthetic fiber, non-woven fabric, urethane, latex, EVA, and the like may be used as said fiber material.

A strap (16) which constitutes the customized sandal (10) according to the present invention is being inserted and fixed between said bottom layer (11) and said middle layer (12), and encompasses the instep. A commonly used sandal upper may be used as said strap (16), and there is no specific limitation thereto.

Hereinafter, a method for producing a customized sandal (10) according to the present invention will be described.

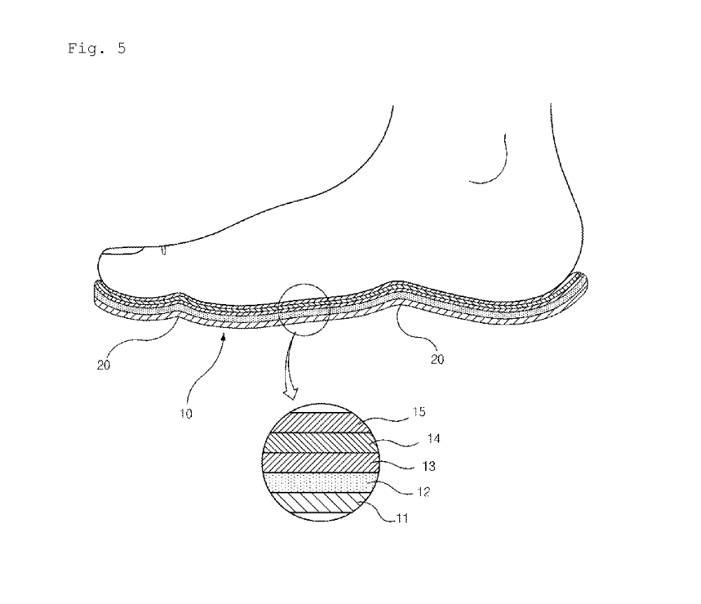

As illustrated in FIGS. 4 and 5, after a bottom layer (11), a middle layer (12), a heating sheet (13), a thermoplastic resin sheet (14), and a surface layer (15) are sequentially stacked, an adhesive is applied on the vertically neighboring stacking surfaces, and then an adhesion process is performed. After that, it is inserted into a press and pressed for a shape of a sole, and then a cutting process is performed to produce a model of a sandal. After that, a strap (16) is inserted between said bottom layer (11) and said middle layer (12) and fixed thereto.

Said thermoplastic resin sheet (14) turns into a moldable state by the heat generated from the heating portion (13a) of the heating sheet (13) when the power is applied through the power supply terminal (17) connected to the electrode portion (13b) of said sandal. At this moment, it is preferred that the power is applied for 10-20 minutes in order to reach a moldable state for said thermoplastic resin sheet (14).

After that, the power source to the power supply terminal (17) is cut-off, and when a wearer steps on said upper layer (15) molding of the thermoplastic resin sheet (14) is accomplished in a shape corresponding to the wearer's weight. More specifically, the big toe area where the weight of the wearer's acts relatively strong is deeply depressed while the small toe area where the weight acts relatively weak is slightly depressed, thereby forming a curved portion (20).

After the completion of the molding of said thermoplastic resin sheet (14), if the thermoplastic resin sheet (14) is cured for about 10-20 minutes at room temperature, a customized sandal (15) according to the present invention perfectly matching with the shape and the characteristics of the wearer's sole is produced.

Said customized sandal (15) may be produced in a way that the electrode portion (13b) is configured to be extended out from the end of the shoe insole as shown in FIG. 4.

As described above, although several preferred embodiments are presented in order to help the understanding of the present invention, the foregoing exemplary embodiments are merely examples of the present invention, it is apparent to a person skilled in the art that various changes and modifications are possible within the scope and the technical spirit of the present invention, and it is obvious that such variations and modifications are also within the scope of the appended claims.

Description of Symbols

| | | | |
|---|---|---|---|
| 1 | customized shoe insole, | 2 | surface layer |
| 3 | upper layer unit, | 4 | heating sheet |
| 4a | heating portion, | 4b | electrode portion |
| 5 | thermoplastic resin sheet, | 6 | power supply terminal |
| 7 | heating circuit, | 8 | cutting line |
| 9 | curved portion, | 10 | customized sandal |
| 11 | bottom layer, | 12 | middle layer |
| 13 | heating sheet, | 13a | heating portion |
| 13b | electrode portion, | 14 | thermoplastic resin sheet |
| 15 | surface layer, | 16 | strap |
| 17 | power supply terminal, | 18 | heating circuit |
| 19 | cutting line, | 20 | curved portion |

1. A customized shoe insole being characterized in that and includes:
a surface layer including a fiber material being contacted with the sole of the wearer's foot;
an upper layer unit being stacked under said surface layer and for absorbing the impact while walking;
a heating sheet being stacked under said upper layer unit and including a heating portion and an electrode portion;
a thermoplastic resin sheet being stacked under said heating sheet and capable of molding thereof by the heat generated in said heating sheet; and
a power supply terminal capable of supplying an AC or a DC to said heating sheet, wherein said heating sheet includes:
a heating portion comprising a heating circuit, wherein said heating circuit is formed by printing with a conductive paint containing fine powder of one or a mixture of two or more elements selected from silver (Ag), carbon (C) or copper (Cu) on a polyethylene (PE), polyethylene terephthalate (PET), polycarbonate (PC) or polyimide (PI) resin film; and
an electrode portion being precisely connected to said heating circuit of said heating portion and the power supply terminal, wherein
said heating circuit is repeatedly arranged by once or twice or more so as to form a zigzag shape with predetermined intervals thereafter, and repeatedly arranged again by once or twice or more so as to form a heating circuit; a cutting line is formed while maintaining at least more than one of said predetermined distance from the heating circuit inwardly from an outer surface of the heating sheet such that said heating sheet is tightly in contact with a foot-shaped thermoplastic resin sheet having a curvature.

2. A customized shoe insole according to claim 1,
being characterized in that said heating circuit and said electrode portion of said heating portion are printed with a conductive paint containing fine powder of one or a mixture of two or more elements selected from silver (Ag), carbon (C) or copper (Cu) using the method of Gravure printing, screen printing, or etching.

3. A customized shoe insole being characterized in that and includes:
a surface layer including a fiber material being contacted with the sole of the wearer's foot;
an upper layer unit being stacked under said surface layer and for absorbing the impact while walking;
a heating sheet being stacked under said upper layer unit and including a heating portion and an electrode portion;
a thermoplastic resin sheet being stacked under said heating sheet and capable of molding thereof by the heat generated in said heating sheet; and
a power supply terminal capable of supplying an AC or a DC to said heating sheet, wherein
said electrode portion is configured to be extended out towards the bottom side of the shoe insole.

4. A customized shoe insole according to claim 1,
being characterized in that a predetermined portion of an the end portion of said electrode portion is reinforced with a carbon ink, and a the remaining portion of said electrode portion is reinforced with an insulating ink, or formed by stacking PE, PET, PC or PI resin film thereon.

5. A customized sandal being characterized in that and includes:
a bottom layer directly contacting the ground;
a middle layer being stacked on the top of said bottom layer for absorbing the impact while walking;
a heating sheet being stacked on the top of said middle layer and including a heating portion and an electrode portion;
a thermoplastic resin sheet being stacked on the top of said heating sheet and capable of molding thereof by the heat generated in said heating sheet;
a surface layer being stacked on the top of said thermoplastic resin sheet and including a fiber material contacting wearer's sole;
a strap being inserted and fixed between said bottom layer and said middle layer, and encompassing the instep; and
a power supply terminal capable of supplying an AC or a DC to said heating sheet, wherein said heating sheet includes:
a heating portion comprising a heating circuit, wherein said heating circuit is formed by printing with a conductive paint containing fine powder of one or a mixture of two or more elements selected from silver (Ag), carbon (C) or copper (Cu) on a polyethylene (PE), polyethylene terephthalate (PET), polycarbonate (PC) or polyimide (PI) resin film; and
an electrode portion being precisely connected to said heating circuit of
said heating portion and the power supply terminal, wherein
said heating circuit is repeatedly arranged by once or twice or more so as to form a zigzag shape with predetermined intervals thereafter, and repeatedly arranged again by once or twice or more so as to form a heating circuit; a cutting line is formed while maintaining at least more than one of said predetermined distance from the heating circuit inwardly from an outer surface of the heating sheet such that said heating sheet is tightly in contact with a foot-shaped thermoplastic resin sheet having a curvature.

6. A customized sandal according to claim 5,
being characterized in that said heating circuit and said electrode portion of said heating portion are printed with a conductive paint containing fine powder of one or a mixture of two or more elements selected from silver (Ag), carbon (C) or copper(Cu) by using the method gravure printing or etching.

7. A customized shoe insole according to claim 5,
being characterized in that a predetermined portion of an the end portion of said electrode portion is reinforced with a carbon ink, and a the remaining portion of said electrode portion is reinforced with an insulating ink, or formed by stacking PE, PET, PC or PI resin film thereon.

8. A customized shoe insole according to claim 6,
being characterized in that a predetermined portion of an end portion of said electrode portion is reinforced with a carbon ink, and a remaining portion of said electrode portion is reinforced with an insulating ink, or formed by stacking PE, PET, PC or PI resin film thereon.

9. A customized shoe insole according to claim 2,
being characterized in that a predetermined portion of an end portion of said electrode portion is reinforced with a carbon ink, and a remaining portion of said electrode portion is reinforced with an insulating ink, or formed by stacking PE, PET, PC or PI resin film thereon.
